(19) United States
(12) Patent Application Publication
(10) Pub. No.: US 2022/0345377 A1
(43) Pub. Date: Oct. 27, 2022

(54) CONTROL APPARATUS, CONTROL METHOD, AND SYSTEM

(71) Applicant: NEC Corporation, Minato-ku, Tokyo (JP)

(72) Inventors: Anan SAWABE, Tokyo (JP); Takanori IWAI, Tokyo (JP)

(73) Assignee: NEC Corporation, Minato-ku, Tokyo (JP)

(21) Appl. No.: 17/641,183

(22) PCT Filed: Sep. 30, 2019
(86) PCT No.: PCT/JP2019/038456

§ 371 Date: Mar. 8, 2022

(51) Int. Cl. H04L 41/16; H04L 41/147

(52) U.S. Cl. CPC H04L 41/16; H04L 41/147

(57) ABSTRACT

In order to provide a control apparatus achieving an efficient control of network using a machine learning, a control apparatus includes a learning unit and a control unit. The learning unit learns an action for controlling the network. The control unit controls the network by setting a control parameter to an apparatus included in the network based on an action obtained from a learning model generated by the learning unit. The control unit decides the control parameter based on an influence of the action obtained from the learning model on a state of the network.

### BACKGROUND

### Technical Field

The present invention relates to a control apparatus, a control method, and a system.

### Background Art

Various services have been provided over a network with the development of communication technologies and information processing technologies. For example, video data is delivered from a server over the network to reproduce the video data on a terminal, or a robot or the like provided in a factory or the like is remotely controlled form a server.

There are many techniques for control of network (see PTLs 1 to 4). PTL 1 describes that a radio communication apparatus is provided which can supply a satisfactory communication quality by assigning one call channel optimal for a radio communication out of a plurality of call channels. PTL 2 describes that a congestion control apparatus and congestion control method are provided which can reduce a packet discarding rate by enabling a behavior of an average buffer length to be predicted in early. PTL 3 describes that an appropriate communication parameter is selected depending on the peripheral state of a radio communication apparatus. PTL 4 describes that a facsimile communication apparatus is provided which can prevent occurrence of communication error by autonomously adjusting communication parameters.

In recent years, a study is underway to apply the machine learning to various fields because of usefulness of the machine learning. For example, a study is underway to apply the machine learning to controlling a game such as chess, or a robot or the like. In the case of applying the machine learning to game management, maximizing a score in the game is configured for a reward to evaluate a performance of the machine learning. In the robot controlling, achieving a goal action is configured for a reward to evaluate a performance of the machine learning. Typically, in the machine learning (reinforcement learning), the learning performance is discussed regarding a total of immediate rewards and rewards in respective episodes.

The machine learning is also incorporated into the control of network. For example, PTL 5 describes that an information processing apparatus, an information processing system, an information processing program, and an information processing method are provided that can reproduce the delay characteristics of a network with ease. The information processing apparatus disclosed in PTL 5 includes a learning processor for learning a plurality of parameters about a learning model that predicts the delay time within the network from the data amount of the traffic per unit time and the delay time.

### CITATION LIST

### Patent Literature

[PTL 1] JP 2003-179970 A
[PTL 2] JP 2011-061699 A
[PTL 3] JP 2013-051520 A
[PTL 4] JP 2019-022055 A
[PTL 5] JP 2019-008554 A

### SUMMARY

### Technical Problem

As described in PTL 5, the machine learning is incorporated into a part of the network control. However, in PTL 5, the machine learning is used only for reproducing the delay characteristics of the network, and it is not achieved that a controller selects a control parameter depending on a state of the network to optimize the state of the network.

The present invention has a main example object to provide a control apparatus, a control method, and a system contributing to achieving an efficient control of network using the machine learning.

### Solution to Problem

According to a first example aspect, there is provided a control apparatus including: a learning unit configured to learn an action for controlling a network; and a control unit configured to control the network by setting a control parameter to an apparatus included in the network based on an action obtained from a learning model generated by the learning unit, wherein the control unit is configured to decide the control parameter based on an influence of the action obtained from the learning model on a state of the network.

According to a second example aspect, there is provided a control method including: learning an action for controlling a network; and controlling the network by setting a control parameter to an apparatus included in the network based on an action obtained from a learning model generated by the learning, wherein the controlling includes deciding the control parameter based on an influence of the action obtained from the learning model on a state of the network.

According to a third example aspect, there is provided a system including: a learning means for learning an action for controlling a network; and a control means for controlling the network by setting a control parameter to an apparatus included in the network based on an action obtained from a learning model generated by the learning means, wherein the control means is configured to decide the control parameter based on an influence of the action obtained from the learning model on a state of the network.

### Advantageous Effects of Invention

According to each of the example aspects of the present invention, provided are a control apparatus, a control method, and a system contributing to achieving an efficient control of network using the machine learning. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is a flowchart illustrating an example of an operation of a control apparatus according to an example embodiment;

FIG. 3 is a diagram illustrating an example of a schematic configuration of a communication network system according to a first example embodiment;

FIG. 4 is a diagram illustrating an example of a Q table;

FIG. 5 is a diagram illustrating an example of a configuration of a neural network;

FIG. 6 is a diagram illustrating an example of weights obtained by reinforcement learning;

FIG. 7 illustrates an example of a processing configuration of a control apparatus according to the first example embodiment;

FIG. 8 is a diagram illustrating an example of information associating a throughput with a congestion level;

FIG. 9 is a diagram illustrating an example of information associating a throughput, a packet loss rate, and a congestion level with each other;

FIG. 10 is a diagram illustrating an example of an internal configuration of a reinforcement learning performing unit;

FIG. 11 is a diagram illustrating an example of information associating a feature with a network state;

FIG. 12 is a diagram illustrating an example of log information generated by a network control unit;

FIG. 13 is a diagram for describing an operation of the network control unit according to the first example embodiment;

FIG. 14 is a flowchart illustrating an example of an operation of the control apparatus in a control mode according to the first example embodiment;

FIG. 15 is a flowchart illustrating an example of an operation of the control apparatus in a learning mode according to the first example embodiment;

FIG. 16 is a diagram for describing an operation of the network control unit according to a second example embodiment; and

FIG. 17 is a diagram illustrating an example of a hardware configuration of the control apparatus.

### DESCRIPTION OF THE EXAMPLE EMBODIMENTS

First of all, an overview of an example embodiment will be described. Note that reference signs in the drawings provided in the overview are for the sake of convenience for each element as an example to promote better understanding, and description of the overview is not to impose any limitations. Note that, in the Specification and drawings, elements to which similar descriptions are applicable are denoted by the same reference signs, and overlapping descriptions may hence be omitted.

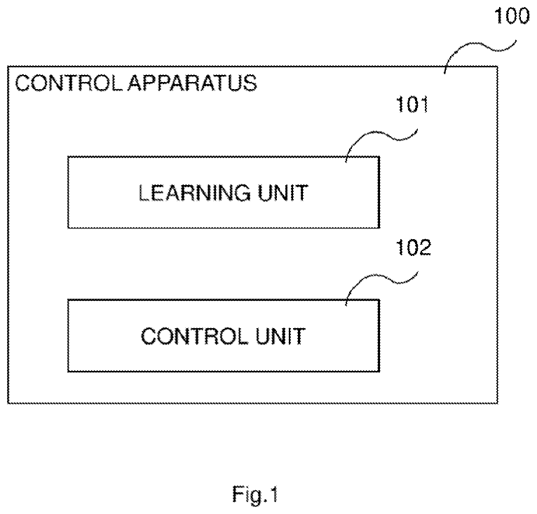

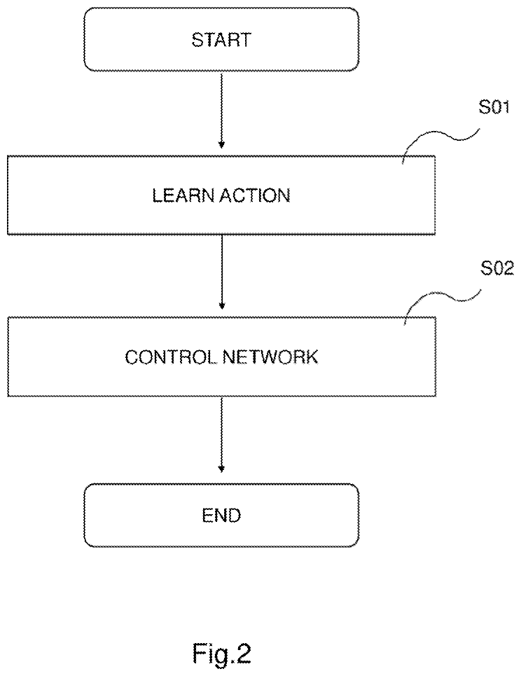

A control apparatus 100 according to an example embodiment includes a learning unit 101 and a control unit 102 (see FIG. 1). The learning unit 101 learns an action for controlling a network (step S01 in FIG. 2). The control unit 102 controls the network by setting a control parameter to an apparatus included in the network based on an action obtained from a learning model generated by the learning unit 101 (step S02 in FIG. 2). At this time, the control unit 102 decides the control parameter based on an influence of the action obtained from the learning model on a state of the network.

The control apparatus 100, when controlling the network, decides an action (the control parameter), not adopting an action obtained from the learning model as it is, but on the basis of an influence of the action on the state of the network. In other words, the control apparatus 100 does not adopt an action having a little influence on the network even if the action is obtained from the learning model. In other words, the control apparatus 100 actively adopts an action expected to be highly effective for the control of network to control the network. As a result, an action useless to the control of network is suppressed and an action useful to the control of network is promoted, which achieves the effective control of network using the machine learning.

Hereinafter, specific example embodiments are described in more detail with reference to the drawings.

### First Example Embodiment

A first example embodiment will be described in further detail with reference to the drawings.

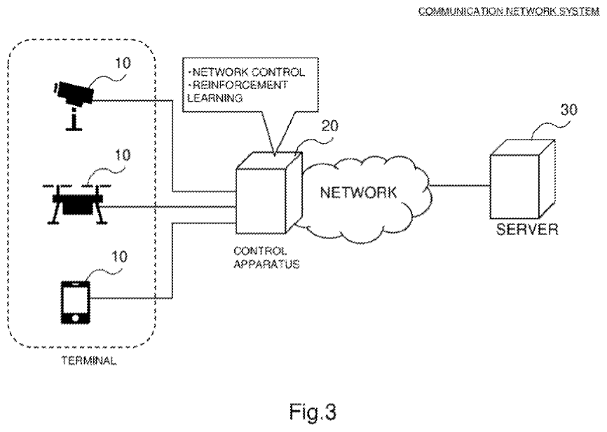

FIG. 3 is a diagram illustrating an example of a schematic configuration of a communication network system according to the first example embodiment. With reference to FIG. 3, the communication network system is configured to include a terminal 10, a control apparatus 20, and a server 30.

The terminal 10 is an apparatus having a communication functionality. Examples of the terminal 10 include a WEB camera, a security camera, a drone, a smartphone, a robot. However, the terminal 10 is not intended to be limited to the WEB camera and the like. The terminal 10 can be any apparatus having the communication functionality.

The terminal 10 communicates with the server 30 via the control apparatus 20. Various applications and services are provided by the terminal 10 and the server 30.

For example, in a case that the terminal 10 is a WEB camera, the server 30 analyzes image data from the WEB camera, so that material management in a factory or the like is performed. For example, in a case that the terminal 10 is a drone, a control command is transmitted from the server 30 to the drone, so that the drone carries a load or the like. For example, in a case that the terminal 10 is a smartphone, a video is delivered toward the smartphone from the server 30, so that a user uses the smartphone to view the video.

The control apparatus 20 is an apparatus controlling the network including the terminal 10 and the server 30, and is, for example, communication equipment such as a proxy server and a gateway. The control apparatus 20 varies values of parameters in a parameter group for a Transmission Control Protocol (TCP) or parameters in a parameter group for buffer control to control the network.

An example of the TCP parameter control includes changing a flow window size. Examples of buffer control include, in queue management of a plurality of buffers, changing the parameters related to a guaranteed minimum band, a loss rate of a Random Early Detection (RED), a loss start queue length, and a buffer length.

Note that in the following description, a parameter having an effect on communication (traffic) between the terminal 10 and the server 30, such as the TCP parameters and the parameters for the buffer control, is referred to as a “control parameter”.

The control apparatus 20 varies the control parameters to control the network. The control apparatus 20 may perform the control of network when the apparatus itself (the control apparatus 20) performs packet transfer, or may perform the control of network by instructing the terminal 10 or the server 30 to change the control parameter.

In a case that a TCP session is terminated by the control apparatus 20, for example, the control apparatus 20 may change a flow window size of the TCP session established between the control apparatus 20 and the terminal 10 to control the network. The control apparatus 20 may change a size of a buffer storing packets received from the server 30, or may change a period for reading packets from the buffer to control the network.

The control apparatus 20 uses the “machine learning” for the control of network. To be more specific, the control apparatus 20 controls the network on the basis of a learning model obtained by the reinforcement learning.

The reinforcement learning includes various variations, and, for example, the control apparatus 20 may control the network on the basis of learning information (Q table) obtained as result of the reinforcement learning referred to as Q-learning.

### [Q-Learning]

Hereinafter, the Q-learning will be briefly described.

The Q-learning makes an “agent” learn to maximize “value” in a given “environment”. In a case that the Q-learning is applied to a network system, the network including the terminal 10 and the server 30 is an “environment”, and the control apparatus 20 is made to learn to optimize a network state.

In the Q-learning, three elements, a state s, an action a, and a reward r, are defined.

The state s indicates what state the environment (network) is in. For example, in a case of the communication network system, a traffic (for example, throughput, average packet arrival interval, or the like) corresponds to the state s.

The action a indicates a possible action the agent (the control apparatus 20) may take on the environment (the network). For example, in the case of the communication network system, examples of the action a include changing configuration of parameters in the TCP parameter group, an on/off operation of the functionality, or the like.

The reward r indicates what degree of evaluation is obtained as a result of taking an action a by the agent (the control apparatus 20) in a certain state s. For example, in the case of the communication network system, the control apparatus 20 changes part of the parameters in the TCP parameter group, and as a result, if a throughput is increased, a positive reward is decided, or if a throughput is decreased, a negative reward is decided.

In the Q-learning, the learning is pursued to not maximize a reward (immediate reward) obtained at a current time point, but maximize value over a future is maximized (a Q table is established). The learning by the agent in the Q-learning is performed so that value (a Q-value, state-action value) when an action a in a certain state s is taken is maximized.

The Q-value (the state-action value) is expressed as Q(s, a). In the Q-learning, an action transitioned to a state of higher value by the agent taking the action is assumed to have value with a degree similar to a transition destination. According to such an assumption, a Q-value at a current time point t can be expressed by a Q-value at the next time point t+1 as below (see Equation (1)).

[Math. 1]

Q(sₜ,aₜ)=Eₛ_{ₜ₊₁}(rₜ₊₁+γEₐ_{ₜ₊₁}(Q(sₜ₊₁,aₜ₊₁))) (1)

Note that in Equation (1), rₜ₊₁ represents an immediate reward, Esₜ₊₁ represents an expected value for a state Sₜ₊₁, and Eaₜ₊₁ represents an expected value for an action aₜ₊₁. γ represents a discount factor.

In the Q-learning, the Q-value is updated in accordance with a result of taking an action a in a certain state s. Specifically, the Q-value is updated in accordance with Relationship (2) below.

[Math. 2]

Q(sₜ,aₜ)←(1−α)Q(sₜ,aₜ)+α(rₜ₊₁+γmaxₐ_{ₜ₊₁}Q(sₜ₊₁,aₜ₊₁)) (2)

In Relationship (2), α represents a parameter referred to as a learning rate, which controls the update of the Q-value. In Relationship (2), “max” represents a function to output a maximum value for the possible actions a in the state Sₜ₊₁. Note that a scheme for the agent (the control apparatus 20) to select the action a may be a scheme called ε-greedy.

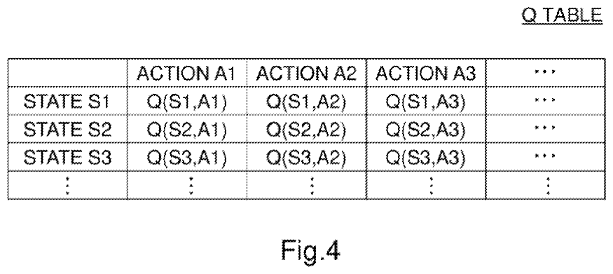

In the ε-greedy scheme, an action is selected at random with a probability ε, and an action having the highest value is selected with a probability 1-ε. Performing the Q-learning allows a Q table as illustrated in FIG. 4 to be generated.

### [Learning Using DQN]

The control apparatus 20 may control the network on the basis of a learning model obtained as a result of the reinforcement learning using a deep learning called Deep Q Network (DQN). The Q-learning expresses the action-value function using the Q table, whereas the DQN expresses the action-value function using the deep learning. In the DQN, an optimal action-value function is calculated by way of an approximate function using a neural network.

Note that the optimal action-value function is a function for outputting value of taking a certain action a in a certain state s.

The neural network is provided with an input layer, an intermediate layer (hidden layer), and an output layer. The input layer receives the state s as input. A link of each of nodes in the intermediate layer has a corresponding weight. The output layer outputs the value of the action a.

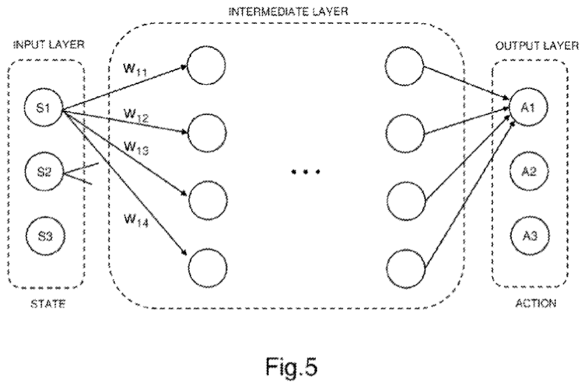

For example, consider a configuration of a neural network as illustrated in FIG. 5. Applying the neural network illustrated in FIG. 5 to the communication network system, nodes in the input layer correspond to network states S1 to S3. The network states input in the input layer are weighted in the intermediate layer and output to the output layer.

Nodes in the output layer correspond to possible actions A1 to A3 that the control apparatus 20 may take. The nodes in the output layer output values of the action-value function Q(st, at) corresponding to the action A1 to A3, respectively.

The DQN learns connection parameters (weights) between the nodes outputting the action-value function. Specifically, an error function expressed by Equation (3) below is set to perform learning by backpropagation.

[Math. 3]

E(sₜ,aₜ)=(t₊₁+γmaxₐ_{ₜ₊₁}Q(sₜ₊₁,aₜ₊₁)−Q(sₜ,aₜ))² (3)

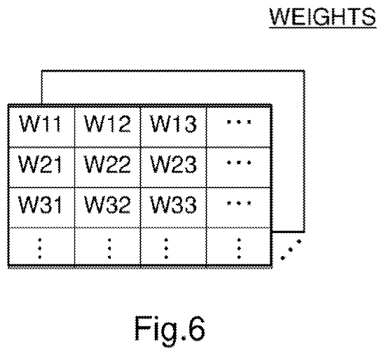

The DQN performing the reinforcement learning allows learning information (weights) to be generated that corresponds to a configuration of the intermediate layer of the prepared neural network (see FIG. 6).

Here, an operation mode for the control apparatus 20 includes two operation modes.

A first operation mode is a learning mode to calculate a learning model. The control apparatus 20 performing the “Q-learning” allows the Q table as illustrated in FIG. 4 to be calculated. Alternatively, the control apparatus 20 performing the reinforcement learning using the “DQN” allows the weights as illustrated in FIG. 6 to be calculated.

A second operation mode is a control mode to control the network using the learning model calculated in the learning mode. Specifically, the control apparatus 20 in the control mode calculates a current network state s to select an action a having the highest value of the possible actions a which may be taken in a case of the state s. The control apparatus 20 performs an operation (control of network) corresponding to the selected action a.

The control apparatus 20 according to the first example embodiment calculates the learning model per a congestion state of the network. For example, in a case that the congestion state of the network is classified into three stages, three learning models corresponding to the respective congestion states are calculated. Note that in the following description, the congestion state of the network is expressed by the “congestion level”.

The control apparatus 20, in the learning mode, calculates the learning model (the learning information such as the Q table or the weights) corresponding to each congestion level. The control apparatus 20 selects a learning model corresponding to a current congestion level among a plurality of learning models (the learning models for the respective congestion levels) to control the network.

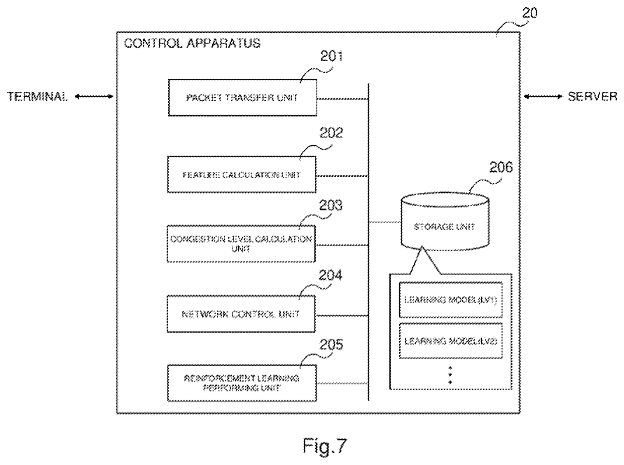

FIG. 7 is a diagram illustrating an example of a processing configuration (a processing module) of the control apparatus 20 according to the first example embodiment. With reference to FIG. 7, the control apparatus 20 is configured to include a packet transfer unit 201, a feature calculation unit 202, a congestion level calculation unit 203, a network control unit 204, a reinforcement learning performing unit 205, and a storage unit 206.

The packet transfer unit 201 is a means for receiving packets transmitted from the terminal 10 or the server 30 to transfer the received packets to an opposite apparatus. The packet transfer unit 201 performs the packet transfer in accordance with a control parameter notified from the network control unit 204.

For example, the packet transfer unit 201 performs, when getting notified of a configuration value of the flow window size from the network control unit 204, the packet transfer using the notified flow window size.

The packet transfer unit 201 delivers a duplication of the received packets to the feature calculation unit 202.

The feature calculation unit 202 is a means for calculating a feature featuring a communication traffic between the terminal 10 and the server 30. The feature calculation unit 202 extracts a traffic flow to be a target of network control from the obtained packets. Note that the traffic flow to be a target of network control is a group consisting of packets having the identical source (Internet Protocol) IP address, destination IP address, port number, or the like.

The feature calculation unit 202 calculates the feature from the extracted traffic flow. For example, the feature calculation unit 202 calculates, as the feature, a throughput, an average packet arrival interval, a packet loss rate, a jitter, or the like. The feature calculation unit 202 stores the calculated feature with a calculation time in the storage unit 206. Note that the calculation of the throughput or the like can be made by use of existing technologies, and is obvious to those of ordinary skill in the art, and thus, a detailed description thereof is omitted.

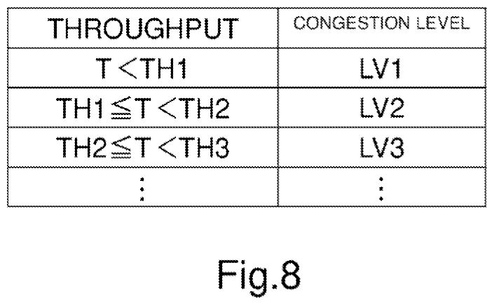

The congestion level calculation unit 203 calculates the congestion level indicating a degree of network congestion on the basis of the feature calculated by the feature calculation unit 202. For example, the congestion level calculation unit 203 may calculate the congestion level in accordance with a range in which the feature (for example, throughput) is included. For example, the congestion level calculation unit 203 may calculate the congestion level on the basis of table information as illustrated in FIG. 8.

In the example in FIG. 8, if a throughput T is equal to or more than a threshold TH1 and less than a threshold TH2, the congestion level is calculated to be “2”.

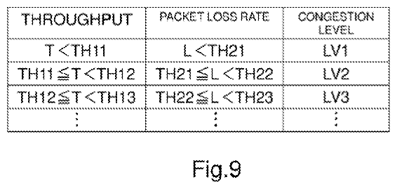

The congestion level calculation unit 203 may calculate the congestion level on the basis of a plurality of features. For example, the congestion level calculation unit 203 may use the throughput and the packet loss rate to calculate the congestion level. In this case, the congestion level calculation unit 203 calculates the congestion level on the basis of table information as illustrated in FIG. 9. For example, in the example in FIG. 9, in a case that the throughput T is included in a range “TH11≤T<TH12” and the packet loss rate is included in a rage “TH21<L≤TH22”, the congestion level is calculated to be “2”.

The congestion level calculation unit 203 delivers the calculated congestion level to the network control unit 204 and the reinforcement learning performing unit 205.

The reinforcement learning performing unit 205 is a means for learning an action for controlling a network (a control parameter). The reinforcement learning performing unit 205 performs the reinforcement learning by the Q-learning or the DQN described above to generate a learning model. The reinforcement learning performing unit 205 is a module mainly operating in the learning mode.

The reinforcement learning performing unit 205 calculates the network state s at the current time t from the feature stored in the storage unit 206. The reinforcement learning performing unit 205 selects an action a from among the possible actions a in the calculated state s by a method like the ε-greedy scheme. The reinforcement learning performing unit 205 notifies the packet transfer unit 201 of the control content (the configuration value of the control parameter) corresponding to the selected action. The reinforcement learning performing unit 205 decides a reward in accordance with a change in the network depending on the action.

For example, the reinforcement learning performing unit 205 sets a reward rₜ+₁ described in Relationship (2) or Equation (3) to a positive value if the throughput increases as a result of taking the action a. In contrast, the reinforcement learning performing unit 205 sets a reward rₜ₊₁ described in Relationship (2) or Equation (3) to a negative value if the throughput decreases as a result of taking the action a.

The reinforcement learning performing unit 205 generates a learning model per a congestion level.

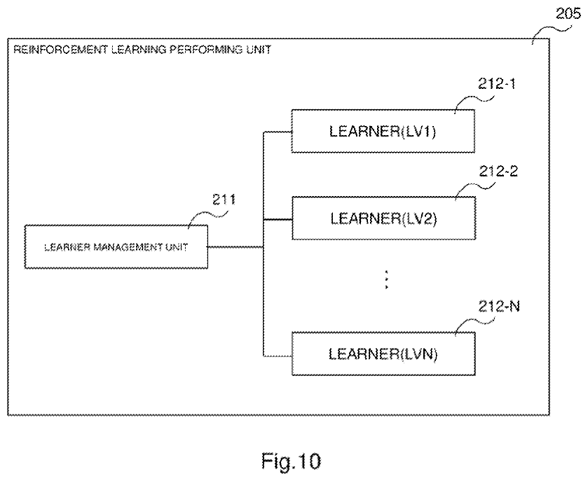

FIG. 10 is a diagram illustrating an example of an internal configuration of the reinforcement learning performing unit 205. With reference to FIG. 10, the reinforcement learning performing unit 205 is configured to include a learner management unit 211 and a plurality of learners 212-1 to 212-N(N represents a positive integer, which applies to the following).

Note that in the following description, the plurality of learners 212-1 to 212-N, in a case of no special reason for being distinguished, are expressed simply as the “learner 212”.

The learner management unit 211 is means for managing an operation of the learner 212.

Each of the plurality of learners 212 learns an action for controlling the network. The learner 212 is prepared per a congestion level. In FIG. 10, the corresponding congestion level is described in parentheses.

The learner 212 calculates the learning model (the Q table, the weights applied to the neural network) per a congestion level to store the calculated learning model in the storage unit 206.

The learner management unit 211 selects a learner 212 corresponding to the congestion level notified from the congestion level calculation unit 203. The learner management unit 211 instructs the selected learner 212 to start learning. The instructed learner 212 performs the reinforcement learning by the Q-learning or the DQN described above.

The description returns to FIG. 7. The network control unit 204 is a means for controlling the network on the basis of the action obtained from the learning model generated by the reinforcement learning performing unit 205. The network control unit 204 decides the control parameter to be notified to the packet transfer unit 201 on the basis of the learning model obtained as a result of the reinforcement learning. At this time, the network control unit 204 selects one learning model from among the plurality of learning models to control the network on the basis of an action obtained from the selected learning model. The network control unit 204 is a module mainly operating in the control mode.

The network control unit 204 selects the learning model (the Q table, the weights) depending on the congestion level notified from the congestion level calculation unit 203. Next, the network control unit 204 reads out the latest feature (at a current time) from the storage unit 206.

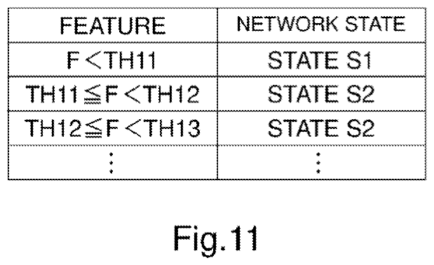

The network control unit 204 estimates (calculates) a state of the network to be controlled from the read feature. For example, the network control unit 204 references a table associating a feature F with a network state (see FIG. 11) to calculate the network state for the current feature F.

Note that a traffic is caused by communication between the terminal 10 and the server 30, and thus, the network state can be recognized also as a “traffic state”. In other words, in the present disclosure, the “traffic state” and the “network state” can be interchangeably interpreted.

FIG. 11 illustrates the case that the network state is calculated from the feature F independently from the congestion level, but the feature may be associated with network state per a congestion level.

In a case that the learning model is established by the Q-learning, the network control unit 204 references the Q table selected depending on the congestion level to acquire an action having the highest value Q of the actions corresponding to the current network state. For example, in the example in FIG. 4, if the calculated traffic state is a “state S1”, and value Q(S1, A1) is maximum among the value Q(S1, A1), Q(S1, A2), and Q(S1, A3), an action A1 is read out.

Alternatively, in a case that the learning model is established by the DNQ, the network control unit 204 applies the weights selected depending on the congestion level to a neural network as illustrated in FIG. 5. The network control unit 204 inputs the current network state to the neural network to acquire an action having the highest value of the possible actions. Note that in the present disclosure, a varied value of the control parameter (an increase or decrease value from the current control parameter) is learned mainly as possible actions the control apparatus 20 may take.

The network control unit 204 performs the action obtained from the learning model to control the network. The network control unit 204 decides the control parameter to be set to the network on the basis of the varied value of the control parameter obtained from the learning model. To be more specific, the network control unit 204 multiplies a varied amount δ_{M} of the control parameter obtained from the learning model by a weight Δ for a current control parameter Pₜ to update a control parameter Pₜ₊₁ to be set to the network, as expressed in Equation (4) below.

[Math. 4]

Pₜ₊₁=Pₜ+Δ*δ_{M} (4)

The network control unit 204 generates control log information when performing the control of network. Specifically, the network control unit 204 generates the control log information that includes the network state, the varied amount of the set control parameter (Pₜ₊₁−Pₜ=Δ*δ_{M}), and a changed amount of the state (Sₜ₊₁−Sₜ).

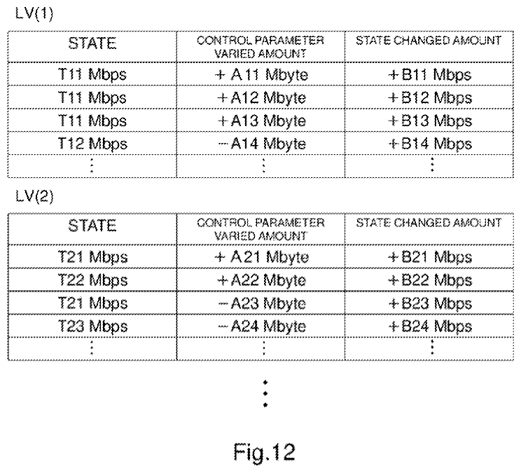

For example, the network control unit 204 generates the control log information as illustrated in FIG. 12 to store the generated information in the storage unit 206. In FIG. 12, the throughput is selected as the feature indicating the network state. The flow window size is selected as the control parameter. For example, in FIG. 12, the first row of a control log corresponding to a congestion level 1 indicates that when the traffic is T11 Mbps, the flow window size is increased by A11 Mbyte, and as a result, the traffic is increased by B11 Mbps. Note that as illustrated in FIG. 12, the network control unit 204 may generate the control log per a congestion level.

The network control unit 204 decides the control parameter to be set to the packet transfer unit 201 on the basis of the action obtained from the learning model. The network control unit 204 controls the network by setting the control parameter with respect to the network on the basis of the action obtained from the learning model generated by the reinforcement learning performing unit 205. At this time, the network control unit 204 decides the control parameter to be set to the network on the basis of an influence of the action obtained from the learning model on the network state.

To be more specific, the network control unit 204 decides the control parameter to be set to the packet transfer unit 201 on the basis of the log information (the control log information) generated by the learner 212 corresponding to the current congestion level. The network control unit 204 extracts a log matching a log extracting condition described below from a log, corresponding to the current congestion level, that is the log information stored in the storage unit 206.

The log extracting condition is that a state described in the log information is substantially equal to a current state, and the changed amount of the network state is larger than a prescribed threshold. Note that “the state is substantially the same” refers to a case that a relationship of S_{L}+β₁≤Sₜ≤S_{L}+β₂ is satisfied, where the state described in the log information is S_{L} and the current state is Sₜ. In other words, a little difference between the state S_{L} and the state Sₜ is absorbed by appropriately selecting β₁ and β₂.

For example, in a case that the current congestion level is “1”, the control log information illustrated in an upper tier in FIG. 12 is selected. If the current network state (the throughput) is “T11 Mbps”, selected are logs on the first to third rows in the logs illustrated in the upper tier in FIG. 12. Furthermore, among the logs on the first to third rows, extracted is a log that any of the network state changed amounts B11 to B13 is larger than a prescribed threshold. For example, if the changed amount B11 is larger than the prescribed threshold, the log on the first row is extracted. Note that in a case that two or more logs that the network state changed amount is larger than a prescribed threshold are included, the control apparatus 20 may extract a log that the network state changed amount is the largest.

The network control unit 204, once extracting the log matching the log extracting condition, determines whether change directions are the same or different between the control parameter corresponding to the action in the extracted log and the control parameter corresponding to the action obtained from the learning model corresponding to the current congestion level.

In a case that both two actions indicate increase or decrease in the control parameter, the network control unit 204 determines that the change directions of the control parameters correspond to “the same direction change”. In contrast, in a case that one control parameter indicates increase and the other control parameter indicates decrease, or in a case of vice versa, the network control unit 204 determines that the change directions of the control parameters correspond to “opposite directions change”.

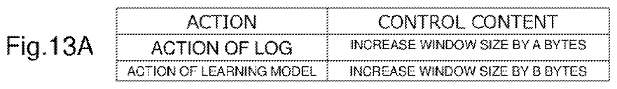

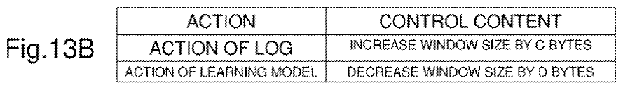

Here, assume a case that the action in the extracted log is “increasing a window size by A bytes”, and the action obtained from the learning model is “increasing a window size by B bytes” (see FIG. 13A). In this case, both two actions indicate increase in the control parameter, and thus, the network control unit 204 determines that the change directions of the control parameters correspond to “the same direction change”.

On the other hand, assume a case that the action in the extracted log is “increasing a window size by C bytes”, and the action obtained from the learning model is “decreasing a window size by D bytes” (see FIG. 13B). In this case, the change directions of the control parameters indicated by two actions are opposite to each other, and thus, the network control unit 204 determines that the change directions of the control parameters correspond to the “opposite directions change”.

In the case that the change directions of the control parameters are determined as the “opposite directions”, the network control unit 204 does not adopt the action obtained from the learning model. In other words, if the change directions of the control parameters are the “opposite directions”, the network control unit 204 discards the action (the control parameter) obtained from the learning model. In this case, the control of network is maintained, and the control parameter set to the packet transfer unit 201 is not changed.

In the case that the change directions of the control parameters are determined as the “same directions”, the network control unit 204 calculates a difference D between the varied value δ_{L} of the control parameter extracted from the log and the varied value SM of the control parameter corresponding to the action obtained from the learning model (see Equation (5) below).

[Math. 5]

D=δ_{L}−δ_{M}

For example, in the example in FIG. 13A, a difference between increases A and B in the window sizes indicated by two actions is calculated (difference D=A−B).

In a case that the difference is equal to or less than a prescribed threshold, the network control unit 204 notifies the packet transfer unit 201 of the control parameter Pₜ₊₁ decided in accordance with Equation (6) below.

[Math. 6]

Pₜ₊₁=Pₜ+Δ₁*δ_{M} (6)

Here, Δ₁ represents a weight multiplied by the varied value δ_{M} of the control parameter obtained from the learning model. Δ₁ represents a numerical value less than 1 (Δ₁<1).

In a case that the difference is larger than the prescribed threshold, the network control unit 204 notifies the packet transfer unit 201 of the control parameter Pₜ₊₁ decided in accordance with Equation (7) below.

[Math. 7]

Pₜ₊₁=Pₜ+Δ₂*δ_{M} (7)

In Equation (7), Δ₂ represents a weight multiplied by the varied value δ_{M} of the control parameter obtained from the learning model. Δ₂ represents a numerical value equal to or more than 1 (Δ₂≥1).

In this way, the network control unit 204 references, when controlling the network, the control log information having been obtained when having controlled the network. The control log information includes the network state, the varied value of the control parameter when having controlled the network, and the changed amount of the state caused by the control of network. The network control unit 204 references the control log information to calculate how degree of influence the action (changing of the control unit parameter) obtained from the learning model has on the network state. Specifically, the network control unit 204 performs threshold processing on a state changed amount of the control log (for example, processing to determine whether the obtained value is not less than, or less than the threshold) to extract an action (changing of the control parameter) having a high influence on the network among the past adopted control parameters.

The network control unit 204 determines using Equation (5) how degree the action (the varied amount of the control parameter) obtained from the learning model is close to the action (the varied amount of the control parameter) having the high influence on the network. In a case that the varied amount of the control parameter from the learning model is substantially the same as the varied amount of the control parameter having the high influence degree (or the difference D is smaller than the threshold), the network control unit 204 weights the control parameter from the learning model by the weight Δ₁ having the value less than 1. For example, if a value of “0.9” or the like is selected as the weight Δ₁, the control of network having had the high influence degree is reproduced.

In contrast, in a case that the varied amount of the control parameter from the learning model does not reach the varied amount of the control parameter having the high influence degree (or the difference D is larger than the threshold), the network control unit 204 weights the control parameter from the learning model by the weight Δ₂ having the value equal to or more than 1. For example, if a value of “1.5” or the like is selected as the weight Δ₁, the control of network can be made closer to that having had the high influence degree.

In this way, the network control unit 204 weights the varied value of the control parameter obtained from the learning model on the basis of a history of past controls (control log information) to perform control such that the network state is optimal. In other words, the network control unit 204 calculates a difference between the varied value of the control parameter obtained from the learning model and the varied value of the control parameter that is included in the control log information and corresponds to a state change where the changed amount of the state caused by the control of network is larger than the threshold. The network control unit 204 extracts the action having the high influence degree by calculating the difference. Then, the network control unit 204 performs the threshold processing on the calculated difference and changes (adjusts) the weight on the basis of a result of the threshold processing to reproduce the action having had the high influence degree in the past.

Note that in the case that the change directions of the control parameters are determined as the “opposite directions”, the network control unit 204 discards the action obtained from the learning model. Such an operation of the network control unit 204 is based on a concept that it is preferable to eliminate (filter) an action adverse to the action having had a large influence (a state change higher than the threshold) in the past state that is in the same state as the current state. On the basis of the same concept, it is preferable to also filter an action having a small influence on the state change (not contributing to worth of the state).

As such, the network control unit 204 references the log information per a congestion level to not adopt an action where the current state is substantially the same as the past state and which is substantially the same as an action that the state changed amount is low (or the changed amount is smaller than a prescribed threshold). The network control unit 204 extracts the log including a state substantially the same as the current state from the control log information per a congestion level. Furthermore, in a case that the corresponding state changed amount in the extracted log is low, and the action obtained from the learning model is the same as an action described in the log, the network control unit 204 discards (filters) the action obtained from the learning model. In other words, in a case that the changed amount of the state caused by the control of network is smaller than a prescribed threshold, the network control unit 204 discards the varied value of the control parameter obtained from the learning model by use of the corresponding network state.

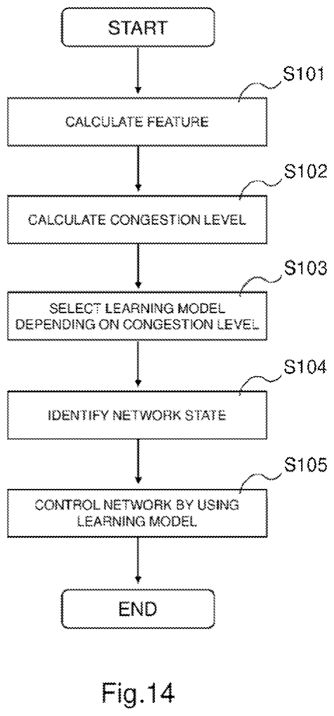

Summarizing the operations of the control apparatus 20 in the control mode according to the first example embodiment, a flowchart as illustrated in FIG. 14 is obtained.

The control apparatus 20 acquires packets to calculate a feature (step S101). The control apparatus 20 calculates a congestion level of the network on the basis of the calculated feature (step S102). The control apparatus 20 selects a learning model depending on the congestion level (step S103). The control apparatus 20 identifies a network state on the basis of the calculated feature (step S104). The control apparatus 20 uses the learning model selected in step S103 to control the network using an action having the highest value depending on the network state (step S105). At this time, the control apparatus 20 modifies the varied value of the control parameter obtained from the learning model in the past on the basis of a control result (the control log).

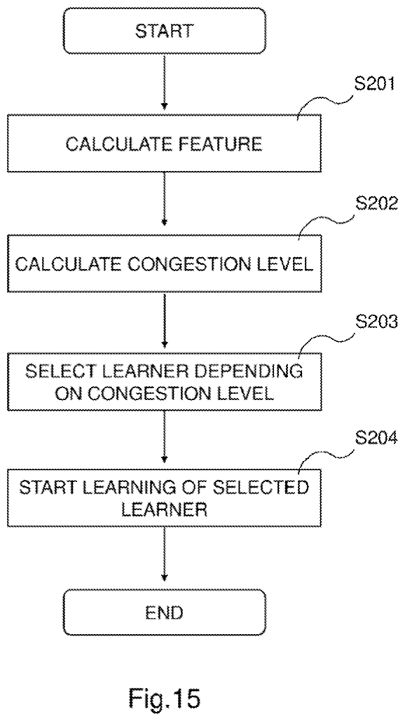

Summarizing the operations of the control apparatus 20 in the learning mode according to the first example embodiment, a flowchart as illustrated in FIG. 15 is obtained.

The control apparatus 20 acquires packets to calculate a feature (step S201). The control apparatus 20 calculates a congestion level of the network on the basis of the calculated feature (step S202). The control apparatus 20 selects a target learner 212 to perform learning depending on the congestion level (step S203). The control apparatus 20 starts learning of the selected learner 212 (step S204). To be more specific, the selected learner 212 performs learning by use of a group of packets (a group of packets including packets observed in the past) observed while a condition that the learner 212 is selected (the congestion level) is satisfied.

As described above, the control apparatus 20 according to the first example embodiment modifies the varied value of the control parameter (the increase or decrease value) output by the learning model in accordance with the past control log. At this time, the control apparatus 20 decides the control parameter based on an influence of the action obtained from the learning model on a state of the network. Here, the network targeted by the control apparatus 20 is often controlled by way of a plurality of and different types of parameters (where the QoS or the like is controlled), and so which parameter is effective for control of network needs to be assessed. As such, the control apparatus 20 decides an update value of the control parameter depending on a strength of the influence on the network by the action (changing of the control parameter) in each state of the network from a past performance of the control of network (the control log information). As a result, the state early transitions (converges) to a state intended by the network state (intended QoS) among a plurality and different types of parameters.

The control of network often controls a parameter, a range of which is actually not finite, such as the window size, or a parameter which is difficult to discretize because a scale (unit width) is large even if a range is defined. For this reason, there is one idea that the window size or the like is not directly specified, but a difference from the current set value (control value) is used to update (decide) the window size. However, in the control using such a difference, the control value may be excessive, or an excess resource may be required relative to an effect. Specifically, the control apparatus 20 handle many flows (traffic flows, or a group of packets identical in the destination), where if the congestion level of the network is the same, the same learning model is selected. As a result, the action adopted for each flow is often the same, and in a case that the same update of the control parameter overlaps for many flows even if the update of the control parameter for one flow is slight, the resource such as the memory is greatly consumed. In other words, in the case that a plurality of learning models are prepared as in the present disclosure, the changing of the control parameter may have a large influence on the resource.

In view of such a circumstance, the control apparatus 20 calculates the influence degree of the control of network with respect to a reward (the state change with respect to the network) from the past control information to not adopt the control parameter having a small influence on the reward. The control parameter having a large influence on the reward is readjusted by deciding a weight on the update value of the control parameter (the increase or decrease value) with the influence degree taken into account.

### Second Example Embodiment

Subsequently, a second example embodiment is described in detail with reference to the drawings.

In the first example embodiment, the network control unit 204 sets (updates) the control parameter to be set to the packet transfer unit 201 on the basis of a history of past network changes (control log information). In the second example embodiment, the update of the control parameter in a case that there is no control log information will be described.

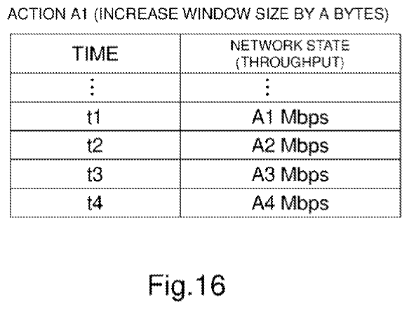

The network control unit 204, every time taking an action on the network (every time setting a control parameter to the packet transfer unit 201), stores a network state caused by the action in the storage unit 206. For example, the network control unit 204 stores the control log information as illustrated in FIG. 16 in the storage unit 206. FIG. 16 illustrates a network state change in a case that the network control unit 204 takes an action A1 (increasing the flow window size by A bytes).

The network control unit 204 inputs the current network state to the learning model to reference the log information related to an action of the same type as the obtained action. For example, in a case that the current network state is input to the learning model and the action A1 is obtained, the network control unit 204 references the log information illustrated in FIG. 16.

The network control unit 204 references the log information to calculate the last network state changed amount D_{S} when taking the action obtained from the learning model. In the example in FIG. 16, the network control unit 204 calculates D_{S}=A4−A3. In other words, the network control unit 204 calculates the network state changed amount before and after updating the control parameter.

If the state changed amount is a negative value, the network control unit 204 discards the action obtained from the learning model. In this case, the network control unit 204 does not take a particular action. Specifically, the network state is likely to degrade if the action obtained from the learning model is taken, and thus, the network control unit 204 does not adopt such an action.

If the state changed amount is a positive value, the network control unit 204 performs threshold processing on the state changed amount (for example, processing to determine whether the obtained value is not less than, or less than the threshold). As a result of the threshold processing, in a case that the state changed amount is equal to or less than the threshold, the control parameter is decided in accordance with Equation (5) described above. As a result of the threshold processing, in a case that the state changed amount is larger than the threshold, the control parameter is decided in accordance with Equation (6) described above.

As described above, the control apparatus 20 according to the second example embodiment, in a case of having taken the action obtained from the learning model (the updating of the control parameter) in the past, decides the control parameter on the basis of a change in a reward (the network state) caused by the update of the control parameter. In other words, similarly to the first example embodiment, in the case that the changing of the control parameter has a good influence on the network state, the control apparatus 20 decides a weight such that the changing of the control parameter is reproduced to update the control parameter. In contrast, in a case that the changing of the control parameter has a good influence on the network state, but a degree thereof is small, the control apparatus 20 decides a weight such that an effect by the changing of the control parameter is increased to update the control parameter. As a result, similarly to the first example embodiment, the state can be early transitioned (converged) to a state intended by the network state (intended QoS).

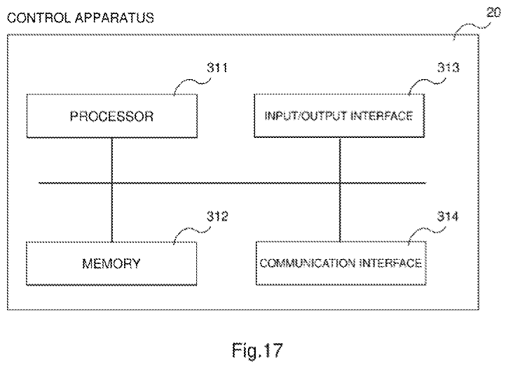

Next, hardware of each apparatus configuring the communication network system will be described. FIG. 17 is a diagram illustrating an example of a hardware configuration of the control apparatus 20.

The control apparatus 20 can be configured with an information processing apparatus (so-called, a computer), and includes a configuration illustrated in FIG. 17. For example, the control apparatus 20 includes a processor 311, a memory 312, an input/output interface 313, a communication interface 314, and the like. Constituent elements such as the processor 311 are connected to each other with an internal bus or the like, and are configured to be capable of communicating with each other.

However, the configuration illustrated in FIG. 17 is not intended to limit the hardware configuration of the control apparatus 20. The control apparatus 20 may include hardware not illustrated, or need not include the input/output interface 313 as necessary. The number of processors 311 and the like included in the control apparatus 20 is not intended to limit to the example illustrated in FIG. 17, and for example, a plurality of processors 311 may be included in the control apparatus 20.

The processor 311 is, for example, a programmable device such as a central processing unit (CPU), a micro processing unit (MPU), and a digital signal processor (DSP). Alternatively, the processor 311 may be a device such as a field programmable gate array (FPGA) and an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display apparatus and an input apparatus (not illustrated). The display apparatus is, for example, a liquid crystal display or the like. The input apparatus is, for example, an apparatus that receives user operation, such as a keyboard and a mouse.

The communication interface 314 is a circuit, a module, or the like that performs communication with another apparatus. For example, the communication interface 314 includes a network interface card (NIC) or the like.

The function of the control apparatus 20 is implemented by various processing modules. Each of the processing modules is, for example, implemented by the processor 311 executing a program stored in the memory 312. The program can be recorded on a computer readable storage medium. The storage medium can be a non-transitory storage medium, such as a semiconductor memory, a hard disk, a magnetic recording medium, and an optical recording medium. In other words, the present invention can also be implemented as a computer program product. The program can be updated through downloading via a network, or by using a storage medium storing a program. In addition, the processing module may be implemented by a semiconductor chip.

Note that the terminal 10 and the server 30 also can be configured by the information processing apparatus similar to the control apparatus 20, and their basic hardware structures are not different from the control apparatus 20, and thus, the descriptions thereof are omitted.

### EXAMPLE ALTERATIONS

Note that the configuration, the operation, and the like of the communication network system described in the example embodiments are merely examples, and are not intended to limit the configuration and the like of the system. For example, the control apparatus 20 may be separated into an apparatus controlling the network and an apparatus generating the learning model. Alternatively, the storage unit 206 storing the learning information (the learning model) may be achieved by an external database server or the like. In other words, the present disclosure may be implemented as a system including a learning means, a control means, a storage means, and the like.

Alternatively, the weight on the control parameter may be changed depending on an environment of the network. For example, in a case of a network with a large packet loss rate such as a wireless Local Area Network (LAN), a weight on the control parameter for suppressing the loss (for example, transmission rate, transmission power) is increased. Alternatively, in a network in which a band between one base station and a terminal is narrow, such as Public Safety Long Term Evolution (PS-LTE) or Low Power Wide Area (LPWA), a weight on a band control is decreased to suppress an adjustment width (varied amount) of the band control. On the other hand, in a case of a fixed network, there is a room for the band, and thus, a weight may be set such that the band control is prioritized.

Alternatively, the weight on the control parameter may be changed depending on a time zone, a position of the terminal 10, or the like. For example, the weight on the control parameter may be changed depending on the time zone such as an early morning, a daytime, an evening, and a midnight. In this case, in the evening, a use rate (a degree of line congestion) of the terminal 10 is large compared to in other time zones, and thus, the weight on the control parameter for the band control is decreased, and so on.

A weight when deciding the control parameter may be changed per a type of the terminal 10, a service, or an application. For example, in a real-time control system such as a robot and a drone, an importance is put on a jitter, and thus, the control apparatus 20 may increase a weight on a parameter controlling the jitter. Alternatively, in a control related to video data such as a video delivery, importance is put on a throughput, and thus, the control apparatus 20 may increase a weight on a parameter controlling the throughput. Alternatively, in control of a telemetry system such as instrumentation control in a remote location, an importance is put on the packet loss rate, and thus, the control apparatus 20 may increase a weight on a parameter controlling the packet loss.

In the control of network, there is a situation requiring, besides automation by the machine control, a manual control by an operator. In a case that both the automated control of the network by the machine control and the manual control by the operator are utilized, the control apparatus 20 may increase a weight on the control parameter changed by the operator, and so on. In other words, the control apparatus 20 may respect the determination by the operator so that the control parameter changed by the operator has a large influence on the network state.

The example embodiments describe the case that the control log information generated by the network control unit 204 is used to modify the action obtained from the learning model (the control parameter). However, the control log information may be used as a log for learning of the learner 212.

The example embodiments describe the case that the control apparatus 20 use the traffic flow as a target of control (as one unit of control). However, the control apparatus 20 may use an individual terminal 10 or a group collecting a plurality of terminals 10 as a target of control. Specifically, the flows even in the identical terminal 10 are handled as different flows because if the applications are different, port numbers are different. The control apparatus 20 may apply the same control (changing the control parameter) to the packets transmitted from the identical terminal 10. Alternatively, the control apparatus 20 may handle, for example, the same type of terminals 10 as one group to apply the same control to the packets transmitted from the terminals 10 belonging to the same group.

In a plurality of flowcharts used in the above description, a plurality of steps (processes) are described in order, but the order of performing of the steps performed in each example embodiment is not limited to the described order. In each example embodiment, the illustrated order of processes can be changed as far as there is no problem with regard to processing contents, such as a change in which respective processes are executed in parallel, for example. The example embodiments described above can be combined within a scope that the contents do not conflict.

The whole or part of the example embodiments disclosed above can be described as in the following supplementary notes, but are not limited to the following.

### (Supplementary Note 1)

A control apparatus (20, 100) including:

a learning unit (101, 205) configured to learn an action for controlling a network; and

a control unit (102, 204) configured to control the network by setting a control parameter to an apparatus included in the network based on an action obtained from a learning model generated by the learning unit (101, 205),

wherein the control unit (102, 204) is configured to decide the control parameter based on an influence of the action obtained from the learning model on a state of the network.

### (Supplementary Note 2)

The control apparatus (20, 100) according to supplementary note 1, wherein the control unit (102, 204) is configured to decide the control parameter based on a varied value of the control parameter obtained from the learning model.

### (Supplementary Note 3)

The control apparatus (20, 100) according to supplementary note 2, wherein the control unit (102, 204) is configured to weight the varied value of the control parameter obtained from the learning model, based on log information including a state of the network obtained when controlling the network, a varied value of the control parameter in controlling the network, and a changed amount of the state caused by controlling of the network.

### (Supplementary Note 4)

The control apparatus (20, 100) according to supplementary note 3, wherein

the control unit (102, 204) is configured to

calculate a difference between the varied value of the control parameter obtained from the learning model and a varied value of the control parameter that is included in the log information and corresponds to a state change where the changed amount of the state caused by controlling of the network is larger than a first threshold, and

change the weight based on the calculated difference.

### (Supplementary Note 5)

The control apparatus (20, 100) according to supplementary note 4, wherein the control unit (102, 204) is configured to, in a case that the changed amount of the state caused by controlling of the network is smaller than a second threshold, discard the varied value of the control parameter obtained from the learning model by use of a corresponding state of the network.

### (Supplementary Note 6)

The control apparatus (20, 100) according to supplementary note 2, wherein the control unit (102, 204) is configured to, in a case of having updated the control parameter obtained from the learning model in the past, decide the control parameter based on a state change of the network caused by updating of the control parameter.

### (Supplementary Note 7)

A control method including:

learning an action for controlling a network; and

controlling the network by setting a control parameter to an apparatus included in the network based on an action obtained from a learning model generated by the learning,

wherein the controlling includes deciding the control parameter based on an influence of the action obtained from the learning model on a state of the network.

### (Supplementary Note 8)

The control method according to supplementary note 7, wherein the controlling includes deciding the control parameter based on a varied value of the control parameter obtained from the learning model.

### (Supplementary Note 9)

The control method according to supplementary note 8, wherein the controlling includes weighting the varied value of the control parameter obtained from the learning model, based on log information including a state of the network obtained when controlling the network, a varied value of the control parameter in controlling the network, and a changed amount of the state caused by controlling of the network.

### (Supplementary Note 10)

The control method according to supplementary note 9, wherein

the controlling includes

calculating a difference between the varied value of the control parameter obtained from the learning model and a varied value of the control parameter that is included in the log information and corresponds to a state change where the changed amount of the state caused by controlling of the network is larger than a first threshold, and

changing the weight based on the calculated difference.

### (Supplementary Note 11)

The control method according to supplementary note 10, wherein the controlling includes, in a case that the changed amount of the state caused by controlling of the network is smaller than a second threshold, discarding the varied value of the control parameter obtained from the learning model by use of a corresponding state of the network.

### (Supplementary Note 12)

The control method according to supplementary note 8, wherein the controlling includes, in a case of having updated the control parameter obtained from the learning model in the past, deciding the control parameter based on a state change of the network caused by updating of the control parameter.

### (Supplementary Note 13)

A system including:

a learning means (101, 205) for learning an action for controlling a network; and

a control means (102, 204) for controlling the network by setting a control parameter to an apparatus included in the network based on an action obtained from a learning model generated by the learning means (101, 205),

wherein the control means (102, 204) is configured to decide the control parameter based on an influence of the action obtained from the learning model on a state of the network.

### (Supplementary Note 14)

The system according to supplementary note 13, wherein the control means (102, 204) is configured to decide the control parameter based on a varied value of the control parameter obtained from the learning model.

### (Supplementary Note 15)

The system according to supplementary note 14, wherein the control means (102, 204) is configured to weight the varied value of the control parameter obtained from the learning model, based on log information including a state of the network obtained when controlling the network, a varied value of the control parameter in controlling the network, and a changed amount of the state caused by controlling of the network.

### (Supplementary Note 16)

The system according to supplementary note 15, wherein

the control means (102, 204) is configured to

calculate a difference between the varied value of the control parameter obtained from the learning model and a varied value of the control parameter that is included in the log information and corresponds to a state change where the changed amount of the state caused by controlling of the network is larger than a first threshold, and

change the weight based on the calculated difference.

### (Supplementary Note 17)

The system according to supplementary note 16, wherein the control means (102, 204) is configured to, in a case that the changed amount of the state caused by controlling of the network is smaller than a second threshold, discard the varied value of the control parameter obtained from the learning model by use of a corresponding state of the network.

### (Supplementary Note 18)

The system according to supplementary note 14, wherein the control means (102, 204) is configured to, in a case of having updated the control parameter obtained from the learning model in the past, decide the control parameter based on a state change of the network caused by updating of the control parameter.

### (Supplementary Note 19)

A program causing a computer (311) mounted on a control apparatus (20, 100) to execute the processes of:

learning an action for controlling a network; and

controlling the network by setting a control parameter to an apparatus included in the network based on an action obtained from a learning model generated by the learning,

wherein the controlling includes deciding the control parameter based on an influence of the action obtained from the learning model on a state of the network.

Note that the disclosures of the cited literatures in the citation list are incorporated herein by reference. Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

### REFERENCE SIGNS LIST

10 Terminal
20, 100 Control Apparatus
30 Server
101 Learning Unit
102 Control Unit
201 Packet Transfer Apparatus
202 Feature Calculation Unit
203 Congestion Level Calculation Unit
204 Network Control Unit
205 Reinforcement Learning Performing Unit
206 Storage Unit
211 Learner Management Unit
212, 212-1 to 212-N Learner
311 Processor
312 Memory
313 Input/Output Interface
314 Communication Interface

What is claimed is:

1. A control apparatus comprising:
a memory storing instructions; and
one or more processors configured to execute the instructions to
learn an action for controlling a network; and
control the network by setting a control parameter to an apparatus included in the network based on an action obtained from a learning model generated by the learning unit,
wherein the one or more processors are further configured to decide the control parameter based on an influence of the action obtained from the learning model on a state of the network.

2. The control apparatus according to claim 1, wherein the one or more processors are further configured to decide the control parameter based on a varied value of the control parameter obtained from the learning model.

3. The control apparatus according to claim 2, wherein the one or more processors are further configured to weight the varied value of the control parameter obtained from the learning model, based on log information including a state of the network obtained when controlling the network, a varied value of the control parameter in controlling the network, and a changed amount of the state caused by controlling of the network.

4. The control apparatus according to claim 3, wherein
the one or more processors are further configured to
calculate a difference between the varied value of the control parameter obtained from the learning model and a varied value of the control parameter that is included in the log information and corresponds to a state change where the changed amount of the state caused by controlling of the network is larger than a first threshold, and
change the weight based on the calculated difference.

5. The control apparatus according to claim 4, wherein the one or more processors are further configured to, in a case that the changed amount of the state caused by controlling of the network is smaller than a second threshold, discard the varied value of the control parameter obtained from the learning model by use of a corresponding state of the network.

6. The control apparatus according to claim 2, wherein the one or more processors are further configured to, in a case of having updated the control parameter obtained from the learning model in the past, decide the control parameter based on a state change of the network caused by updating of the control parameter.

7. A control method comprising:
learning an action for controlling a network; and
controlling the network by setting a control parameter to an apparatus included in the network based on an action obtained from a learning model generated by the learning,
wherein the controlling includes deciding the control parameter based on an influence of the action obtained from the learning model on a state of the network.

8. The control method according to claim 7, wherein the controlling includes deciding the control parameter based on a varied value of the control parameter obtained from the learning model.

9. The control method according to claim 8, wherein the controlling includes weighting the varied value of the control parameter obtained from the learning model, based on log information including a state of the network obtained when controlling the network, a varied value of the control parameter in controlling the network, and a changed amount of the state caused by controlling of the network.

10. The control method according to claim 9, wherein
the controlling includes
calculating a difference between the varied value of the control parameter obtained from the learning model and a varied value of the control parameter that is included in the log information and corresponds to a state change where the changed amount of the state caused by controlling of the network is larger than a first threshold, and
changing the weight based on the calculated difference.

11. The control method according to claim 10, wherein the controlling includes, in a case that the changed amount of the state caused by controlling of the network is smaller than a second threshold, discarding the varied value of the control parameter obtained from the learning model by use of a corresponding state of the network.

12. The control method according to claim 8, wherein the controlling includes, in a case of having updated the control parameter obtained from the learning model in the past, deciding the control parameter based on a state change of the network caused by updating of the control parameter.

13. A system comprising:
a learning apparatus configured to learn an action for controlling a network; and
a control apparatus including a memory storing instructions, and one or more processors configured to execute the instructions to control the network by setting a control parameter to an apparatus included in the network based on an action obtained from a learning model generated by the learning apparatus,
wherein the one or more processors are further configured to decide the control parameter based on an influence of the action obtained from the learning model on a state of the network.

14. The system according to claim 13, wherein the one or more processors are further configured to decide the control parameter based on a varied value of the control parameter obtained from the learning model.

15. The system according to claim 14, wherein the one or more processors are further configured to weight the varied value of the control parameter obtained from the learning model, based on log information including a state of the network obtained when controlling the network, a varied value of the control parameter in controlling the network, and a changed amount of the state caused by controlling of the network.

16. The system according to claim 15, wherein
the one or more processors are further configured to
calculate a difference between the varied value of the control parameter obtained from the learning model and a varied value of the control parameter that is included in the log information and corresponds to a state change where the changed amount of the state caused by controlling of the network is larger than a first threshold, and
change the weight based on the calculated difference.

17. The system according to claim 16, wherein the one or more processors are further configured to, in a case that the changed amount of the state caused by controlling of the network is smaller than a second threshold, discard the varied value of the control parameter obtained from the learning model by use of a corresponding state of the network.

18. The system according to claim 14, wherein the one or more processors are further configured to, in a case of having updated the control parameter obtained from the learning model in the past, decide the control parameter based on a state change of the network caused by updating of the control parameter.
